(19) United States
(12) Patent Application Publication
(10) Pub. No.: US 2014/0067467 A1
(43) Pub. Date: Mar. 6, 2014

(54) ADJACENCY OPTIMIZATION SYSTEM FOR PRODUCT CATEGORY MERCHANDISING SPACE ALLOCATION

(71) Applicants: Bharath Kumar Rangarajan, Minneapolis, MN (US); James C. Nelson, Minneapolis, MN (US); Abhishek Singh Verma, Bangalore (IN)

(72) Inventors: Bharath Kumar Rangarajan, Minneapolis, MN (US); James C. Nelson, Minneapolis, MN (US); Abhishek Singh Verma, Bangalore (IN)

(73) Assignee: TARGET BRANDS, INC., Minneapolis, MN (US)

(21) Appl. No.: 13/601,680

(22) Filed: Aug. 31, 2012

(51) Int. Cl. G06Q 30/02

(52) U.S. Cl. 705/7.31; 705/7.29

(57) ABSTRACT

A system is disclosed for optimizing product merchandising area allocation. One example includes receiving inputs defining financial metrics for product categories. A linear regression model forecasts responses of the financial metrics for the product categories to endogenous variables, which include sales per merchandising area per product category per store and total sales volume per store. Each of the product categories includes a user option to select constraints for either a minimum and maximum of an area in which the product category is displayed, or a minimum and maximum change from a current area in which the product category is displayed. The system generates a merchandising plan that optimizes for the combined total of the financial metrics of the product categories in accordance with the linear regression model, including changes in merchandising area for each of a plurality of the product categories, within the selected constraints.

### TECHNICAL FIELD

This disclosure relates to merchandising, and more particularly, to software for automating aspects of organizing product placement in retail stores.

### BACKGROUND

Modern large retail stores provide a great variety of products, such as tens of thousands of different products at one time. Planning the physical arrangement of all of these products in a store, which may be referred to as “merchandise presentation planning,” may be a complex and arduous task. How all of these products are physically arranged in the store may make a great difference in whether customers can easily find what they're looking for, how they make shopping decisions, what products they ultimately purchase, how they enjoy their overall shopping experience, and how their shopping habits are shaped. How all of the products are physically arranged in the store may therefore also make a great difference in margins and profits for the retail store.

In addition to the sheer number of products to be placed in the retail store, many additional factors further complicate the process of merchandise presentation planning. A retail enterprise may have many store locations with different sizes, dimensions, and features, so that a merchandise presentation plan generated for one store's layout may be inapplicable to a different store, which may have very different size, layout, or architectural constraints. Additionally, product vendors typically often update or retire products and introduce new products. The retail enterprise may regularly analyze sales patterns and market shifts and decide to cancel product lines, decrease or increase the amount of inventory and shelf space to devote to different product lines, or begin carrying new product lines. The retail enterprise may also shift its product mix at different times of year, including to carry summer clothing and winter clothing at the appropriate times, to carry other seasonal-related products at the appropriate times such as shovels in the winter and sunscreen in the summer, and to carry holiday-related items leading up to various holidays. The retail enterprise may also cater to different regionally varying market demands with products that are particularly in demand in certain geographical regions. These factors all contribute further complexity to the process of merchandise presentation planning across retail stores for a retail enterprise.

### SUMMARY

In general, this disclosure is directed to methods, computing systems, and software for optimizing merchandising area allocation for product categories or adjacency groups in retail merchandise presentation planning.

One example is for a method of using a computing system for generating an optimized product merchandising plan determining an allocated merchandising area per product category. The method includes receiving user inputs defining a financial metric for each of a plurality of product categories assigned to a product department. The method further includes providing a linear regression model that forecasts responses of the financial metrics for each of the product categories to endogenous variables, wherein the endogenous variables comprise historical sales per merchandising area per product category for each of a plurality of stores, and historical total sales volume for each of the plurality of stores. The method further includes, for each of the product categories, enabling a user option to select either a minimum and maximum of an area in which the product category may be displayed, or a minimum and maximum change from a current area in which the product category is displayed. The method further includes generating a merchandising plan for the product department that optimizes for the combined total of the financial metrics of the product categories for the product department in accordance with the linear regression model, within constraints of the selected minimums and maximums of display area or minimum and maximum change from the current display area for each of the product categories. The method further includes generating an output based on the merchandising plan for the product department. The output comprises changes in merchandising area for each of a plurality of the product categories.

Another example of this disclosure is directed to a computing system that includes one or more processors, one or more computer-readable tangible storage devices, a display device, a user input device, and program instructions stored on at least one of the one or more computer-readable tangible storage devices. The computing system includes program instructions to receive user inputs defining a financial metric for each of a plurality of product categories assigned to a product department. The computing system further includes program instructions to provide a linear regression model that forecasts responses of the financial metrics for each of the product categories to endogenous variables, wherein the endogenous variables comprise historical sales per merchandising area per product category for each of a plurality of stores, and historical total sales volume for each of the plurality of stores. The computing system further includes program instructions, stored on at least one of the one or more computer-readable tangible storage devices, for each of the product categories, to enable a user option to select either a minimum and maximum of an area in which the product category may be displayed, or a minimum and maximum change from a current area in which the product category is displayed. The computing system further includes program instructions, stored on at least one of the one or more computer-readable tangible storage devices, to generate a merchandising plan for the product department that optimizes for the combined total of the financial metrics of the product categories for the product department in accordance with the linear regression model, within constraints of the selected minimums and maximums of display area or minimum and maximum change from the current display area for each of the product categories. The computing system further includes program instructions, stored on at least one of the one or more computer-readable tangible storage devices, to generate an output based on the merchandising plan for the product department. The output comprises changes in merchandising area for each of a plurality of the product categories.

Another example of this disclosure is directed to a computer program product that includes one or more computer-readable tangible storage devices, and program instructions stored on at least one of the one or more computer-readable tangible storage devices. The computer program product includes program instructions to receive user inputs defining a financial metric for each of a plurality of product categories assigned to a product department. The computer program product further includes program instructions to provide a linear regression model that forecasts responses of the financial metrics for each of the product categories to endogenous variables, wherein the endogenous variables comprise historical sales per merchandising area per product category for each of a plurality of stores, and historical total sales volume for each of the plurality of stores. The computer program product further includes program instructions, for each of the product categories, to enable a user option to select either a minimum and maximum of an area in which the product category may be displayed, or a minimum and maximum change from a current area in which the product category is displayed. The computer program product further includes program instructions to generate a merchandising plan for the product department that optimizes for the combined total of the financial metrics of the product categories for the product department in accordance with the linear regression model, within constraints of the selected minimums and maximums of display area or minimum and maximum change from the current display area for each of the product categories. The computer program product further includes program instructions to generate an output based on the merchandising plan for the product department. The output comprises changes in merchandising area for each of a plurality of the product categories.

The details of one or more embodiments of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example of an adjacency optimization system at use within the context of a retail enterprise.

FIG. 2 is a graphical output representing physical store layout data for a store, which may be provided in a user interface for an adjacency optimization system in accordance with aspects of this disclosure.

FIG. 3 is a graphical output representing physical store layout data for a portion of a store, which may be provided in a user interface for an adjacency optimization system in accordance with aspects of this disclosure.

FIG. 4 is a graphical output of a product category map for a product department within the store layout of a store, which may be provided in a user interface for an adjacency optimization system in accordance with aspects of this disclosure.

FIG. 5 depicts two illustrative graphs of historical sales per merchandising area for a selected product category in a selected store.

FIG. 6 is a block diagram illustrating exogenous variables and endogenous variables that are provided to a linear regression model for an adjacency optimization system in accordance with aspects of this disclosure.

FIG. 7 is a flowchart illustrating an example method of operation of an adjacency optimization system in accordance with an example of this disclosure.

FIG. 8 depicts an output based on a merchandising plan for a product department in accordance with an example of this disclosure.

FIG. 9 depicts an output based on a merchandising plan for a product department in accordance with an example of this disclosure.

FIG. 10 depicts an output based on a merchandising plan for a product department in accordance with an example of this disclosure.

FIG. 11 is a block diagram illustrating an example implementation of a computing device that may implement an adjacency optimization system in accordance with aspects of this disclosure.

### DETAILED DESCRIPTION

As used throughout this disclosure, headings are included to improve the clarity of the disclosure and are not necessarily used to define separate embodiments. In various examples, features of various embodiments may be combined and/or used from among contents discussed under multiple headings in accordance with aspects of the present disclosure.

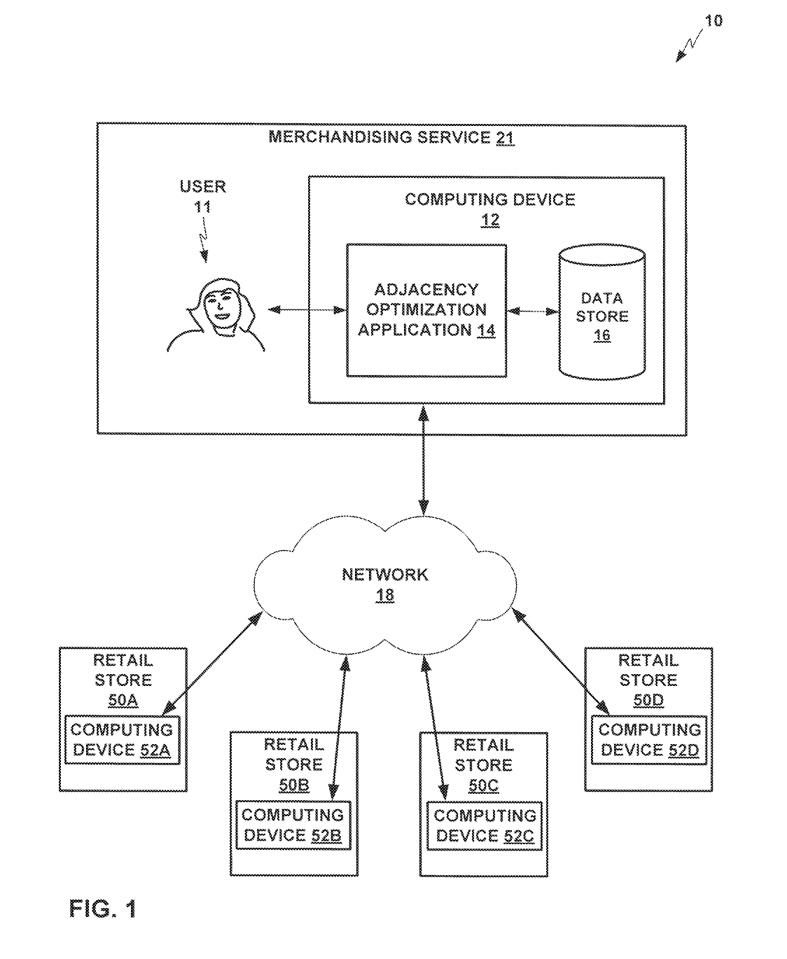

FIG. 1 is a block diagram illustrating an example of an adjacency optimization application 14 within the context of an enterprise system 10. User 11 and computing device 12 are part of a merchandising service 21 of a retail enterprise. User 11 may use adjacency optimization application 14 running on computing device 12 as part of a merchandising service function, and communicate data via network 18 back and forth with computing devices 52A, 52B, 52C, and 52D (“computing devices 52A-52D”) at representative retail stores 50A, 50B, 50C, 50D (“retail stores 50A-50D”) that are part of the retail enterprise. User 11 and computing device 12 may thereby communicate data rapidly to computing devices 52A-D at retail stores 50A-D, including merchandising plan outputs generated by computing device 12.

User 11 may therefore use adjacency optimization application 14 to generate merchandising plan outputs for product departments, and then send the merchandising plan outputs from merchandising service 21 to retail stores 50A-D. While four retail stores are illustratively depicted in FIG. 1, enterprise system 10 may include any number of retail stores, from one or two to hundreds or thousands or more.

Adjacency optimization application 14 may make use of a variety of data stored in data store 16. Data store 16 may include a standard or proprietary database or other data storage and retrieval mechanism. Data store 16 may each be implemented in software, hardware, and combinations of both. For example, data store 16 may include proprietary database software stored on one of a variety of storage mediums on a data storage server connected to computing device 12 and configured to send data to and collect data from computing device 12. Storage mediums included in or employed in cooperation with data stores 26 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

In various examples, computing device 12 at merchandising service 21 and computing devices 52A-D at retail stores 50A-D may be communicatively connected via a network 18. The network 18 may include one or more terrestrial and/or satellite networks interconnected to provide a means of communicatively connecting computing device 12 and computing devices 52A-D. For example, the network 18 may include an enterprise intranet, a private or public local area network, or a wide area network, including, for example, the Internet. The network 18 may include both wired and wireless communications according to one or more standards and/or via one or more transport mediums. For example, the network may include wireless communications according to one of the 802.11 or Bluetooth specification sets, or another standard or proprietary wireless communication protocol. The network 18 may also include communications over a terrestrial cellular network, including, e.g. a GSM (Global System for Mobile Communications), CDMA (Code Division Multiple Access), and/or EDGE (Enhanced Data for Global Evolution) network. Data transmitted over the network 18, e.g., between computing device 12 and computing devices 52A-D, may be formatted in accordance with a variety of different communications protocols. For example, all or a portion of the network may be a packet-based, Internet Protocol (IP) network that communicates data between computing device 12 and computing devices 52A-D in Transmission Control Protocol/Internet Protocol (TCP/IP) packets, over, e.g., Ethernet via Category 5 cables.

Computing device 12 and computing devices 52A-D may include any number and variety of different computing devices. For example, computing device 12 and computing devices 52A-D may include networked computing devices that include network communication elements configured to send and receive data via a network. Examples of computing device 12 and computing devices 52A-D may include desktop computers, tablet computers, laptop computers, smartphones, or other portable, non-portable, or mobile devices. While the example of FIG. 1 illustratively depicts one computing device 12 at merchandising service 21 and four computing devices 52A-D with one at each of retail stores 50A-D, other examples may include any number of co-located or distributed computing devices at merchandising service 21 and at each of any number of retail stores, which may for example number in the hundreds or thousands, in that implement techniques of this disclosure.

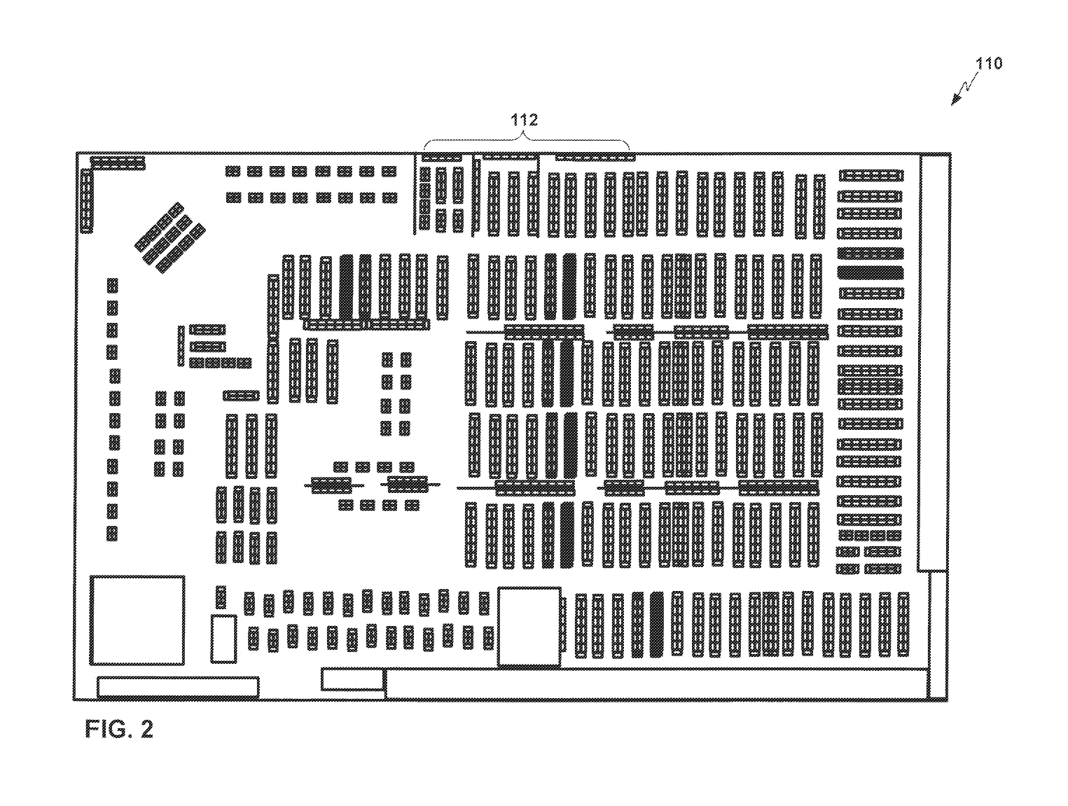

FIG. 2 is a physical store layout graphical output 110 representing physical store layout data for a store, that provides an illustrative context for evaluating and allocating merchandising space data, such as may be used for an adjacency optimization application in accordance with aspects of this disclosure. Store layout graphical output 110 may in one example be provided in a computing device user interface, such as for computing device 12 at merchandising service 21 of FIG. 1. The physical store layout data represented in store layout graphical output 110 may include architectural plans and positions and dimensions of walls, shelves, racks, and other merchandising fixtures, for a specific store layout. The physical store layout data represented in store layout graphical output 110 may be stored along with stored layout data for other store layouts in data store 16 of computing device 12 as shown in FIG. 1, or computing device 12 may access such data from another local or network resource, for example. In other examples, computing device 12 may use merchandising space data that makes reference to store layout data of various retail stores, without necessarily including or making reference to a representative graphical output like that shown in FIG. 2.

Different stores may have various different store layouts. A specific store layout may have at least some standardized layout sections applicable to multiple stores, or a unique store layout that may have product adjacency group layouts that apply only to a single store. As used herein, a product adjacency group refers to a product department that includes a variety of related products that are classified for being put on merchandising display proximate to each other in a retail store in a merchandising plan. As used herein, the terms “product adjacency group” and “product department” may be used interchangeably. The products in a product adjacency group or product department may be segmented into narrower categories of more closely products, and which may be organized into one or more hierarchical layers of categorization. For example, a “pets” product department may be defined for all pet-related products to be put on merchandising display proximate to each other in a section of a retail store, and the “pets” product department may be segmented into particular product categories such as “cat food” and “dog food”. These categories may be further segmented in turn into narrower product categories for more closely related or more narrowly defined categories such as for particular types or brands of cat food that still have more than one specific product included therein.

A retail enterprise may have a number of different standardized merchandising space layout portions, each of which may apply to multiple stores. For example, a retail enterprise may have standardized shelving sections of a selected area with a standardized width, such as four feet in width in one illustrative example, as well as with a standardized height. Merchandising space planning may be processed in terms of standardized sections of such selected width, with the selected width and standardized height defining a selected area, or otherwise in terms of a selected unit of area. Some merchandising space sections may also be defined in terms of a selected depth as well as width and height. A retail enterprise may also have some stores with atypical or unique physical store layouts, such as older stores that pre-date a layout standardization, or stores installed in legacy structures that were not originally constructed by the retail enterprise and that may have product adjacency group layouts that are unique compared with the rest of the stores belonging to the retail enterprise. Flexible modifications of the standardized selected width or other selected area may be applied to such irregular merchandising space sections.

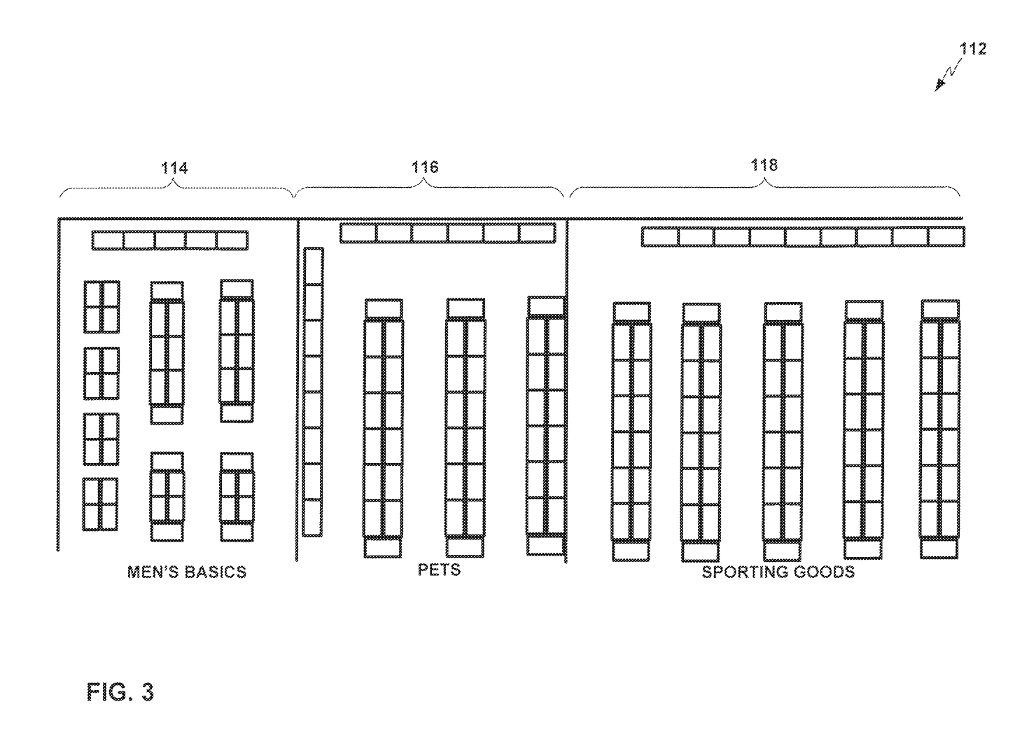

A store layout data store may contain data for each of the physical store layouts for each of the stores belonging to the retail enterprise. The store layout data store may also contain data for an index or a correspondence that indicates which of the stored physical store layouts correspond to which stores. The physical store layout may be assigned different sections that define adjacency groups. A layout portion 112 of physical store layout graphical output 110 may be used as a representative example to illustrate the assignment of different sections of a store layout into different adjacency groups, as further illustrated in FIG. 3.

FIG. 3 is a graphical output representing physical store layout data for a portion of a store layout 112, that may in one example be provided in a user interface, such as for computing device 12 shown in FIG. 1, such as may be used for an adjacency optimization application in accordance with aspects of this disclosure. Store layout portion 112 includes smaller portions of the store layout that have been segmented into product adjacency groups, i.e. product departments; in particular, a “Men's Basics” product department 114, a “Pets” product department 116, and a “Sporting Goods” product department 118. A product adjacency group may be a portion of a store layout that is assigned to a particular department or division of products that are logically categorized together in a group, and/or that may be advantageously grouped and presented together or in adjacent groups for merchandising display purposes. An adjacency group may be for a product division that contains multiple product categories and/or departments that corresponds to a logical arrangement that may conform to retail customer expectations about what to find together, or that may be conducive to cross-selling related products for a retail customer seeking a particular product, for example. Various factors considered for organizing adjacency groups may include data and patterns on sales volume, location attributes, and customer demographics thr particular product categories, for example.

The categorization of products into hierarchical levels of relatedness, such as into product departments and product categories, may be defined in accordance with substantial market and sales research. The categorization of products into levels of relatedness such as adjacency groups may be stored as data in data store 16 of FIG. 1, for example. Data store 16 may also store extensive data on each individual product, including the individual product's size and dimensions, as well as its weight, normal price, markdown price, vendor, SKU number, forecasted popularity, inventory policy, and so forth, for example.

The portion of a store layout assigned to a particular adjacency group may be considered the floorpad of that adjacency group. The floorpad for the adjacency groups 114, 116, and 118, as represented in the store layout in FIG. 3, of shelves, racks, and other merchandising fixtures derived from the store layout data, may correspond to the physical arrangement and dimensions of the actual merchandising fixtures in particular retail stores, which may correspond to retail stores 50A-D shown in FIG. 1.

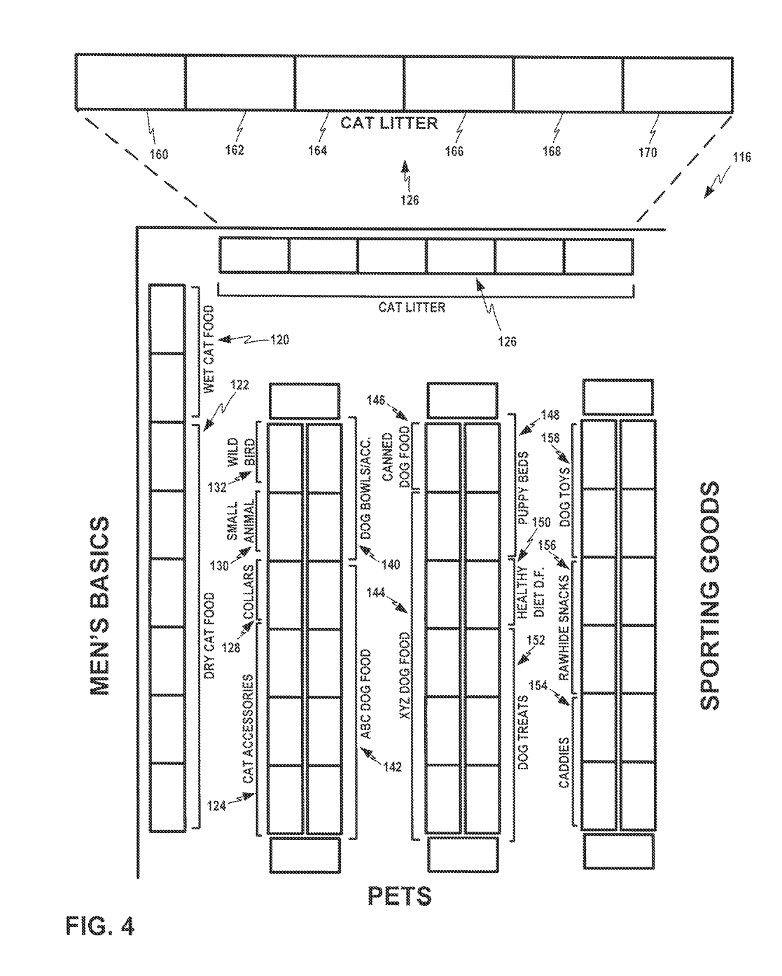

FIG. 4 is a graphical output of a product category map for the “Pets” product department 116 within the store layout of a retail store, such as may be used for an adjacency optimization application in accordance with aspects of this disclosure. The product category map for product department 116 may be provided in a computing device user interface, such as for computing device 12 at merchandising service 21 of FIG. 1. A product category may be defined as a narrower level of categorization within a product department, such as a single category or family of products within a product department, for example, such as the illustrative product categories shown mapped in FIG. 4. For purposes of FIG. 4, the reference number 116 may refer both to the “Pets” product department in general, and to the rendering of the product category map for the “Pets” product department, with the product category mapping assignments superimposed on the store layout section assigned to the product department as depicted in FIG. 4.

The product category map 116 is a map of where different product categories are positioned or are intended to be positioned within the “Pets” product adjacency group. As shown in FIG. 4, the floor plan assigned to the “Pets” product adjacency group shows rows of structures that represent shelves, racks, and/or other merchandising fixtures, and these merchandising fixtures are divided into many separate sections. Each of the product categories are assigned to one or more of these sections, as shown in FIG. 4. This mapping of each product category to one or more sections of the merchandising fixtures in the “Pets” adjacency group is shown in an exploded view of one of the particular product categories, the “cat litter” product category 126 seen at the top of FIG. 4. The “cat litter” product subgroup 126 included six different, adjacent merchandising fixture sections 160, 162, 164, 166, 168, 170 (“fixture sections 160-170”). Each of fixture sections 160-170 may represent a certain area of merchandising fixtures. For example, each of fixture sections 160-170 may represent a four-foot-wide section of a column of shelves or racks assembled against a watt. Many or all of the other fixture sections depicted in FIG. 4 may each also represent a four-foot-wide section of a column of shelves or racks assembled against either a wall or a free-standing gondola that is positioned on the floor apart from a wall but that also supports shelves, racks, or other merchandising fixtures. In other examples, other sizes or dimensions of sections of merchandising fixtures or merchandising space may also be used.

Product adjacency groups such as the “Pets” product department 116 and product categories such as the “cat litter” product category 126 and the other product categories mapped out in the “Pets” product department 116 as shown in FIG. 4 therefore form part of a hierarchical planning organization for merchandising products in a retail store space. This hierarchical organization of product merchandising may also extend down to another, finer level of detail below the level of the product categories, where each individual product category may be associated with a corresponding planogram. A planogram may be a mapping of individual products and how these individual products are displayed or presented within a particular product category.

Whereas the product departments, i.e. adjacency groups, and the product categories may be mapped from a vertical, bird's-eye view perspective of the floor plan of the store layout, a planogram may be mapped from a horizontal view corresponding to the view of a customer standing in the store looking at the products as they are positioned in or on the merchandising fixtures in any given product subgroup. Each fixture section, such as fixture sections 160-170, in a product subgroup may therefore correspond one-to-one with a particular planogram that shows a map of where and how all of the products intended for that fixture section are intended to be arranged on the merchandising fixtures in that product subgroup. A fixture section may therefore also be referred to as a planogram section. These fixture sections, i.e. planogram sections, may therefore define a standardized smallest unit of merchandising area to which a given product category may be assigned. Taken together, therefore, the organizational levels of products departments, product categories, and planograms may provide a comprehensive and logical hierarchical organizational structure for planning and assigning how all of the available products may be positioned in a logical and coherent manner throughout a retail store. A product category may therefore be a business title to refer to planogram footage and merchandising display information for particular categories of products.

As shown in FIG. 4, the product category map 116 for the “Pets” product department includes a number of other product categories in addition to the “cat litter” product category 126 with its six planogram section, and each of the product categories is shown with one or more assigned planogram sections as units of merchandising area assigned to that product category. In particular, in this example, product category map 116 also includes a “wet cat food” product category 120 with two planogram sections, a “dry cat food” product category 122 with six planogram sections, a “cat accessories” product category 124 with three planogram sections, a “collars” product category 128 with one planogram section, a “small animal” product category 130 with one planogram section, a “wild bird” product category 132, with one planogram section, a “dog bowls and accessories” product category 140 with two planogram sections, an “ABC brand dog food” product category 142 with four planogram sections, an “XYZ brand dog food” product category 144 with five planogram sections, a “canned dog food” product category 146 with one planogram section, a “puppy beds” product category 148 with two planogram sections, a “healthy diet dog food” product category 150 with one planogram section, a “dog treats” product category 152 with three planogram sections, a “caddies” product category 154 with two planogram sections, a “rawhide snacks” product category 156 with two planogram sections, and a “dog toys” product category 158 with two planogram sections. Each of these product categories is therefore assigned one or more planogram sections within the merchandising fixtures rendered in the store layout portion of the “Pets” product department. The product category map 116 for the “Pets” product adjacency group therefore provides a detailed map that shows how many planogram sections or other units of merchandising area are assigned to each of the product categories in the product department.

A retail enterprise may reorganize the merchandising presentation of products from time to time, such as the products within the “Pets” product adjacency group. The retail enterprise may re-evaluate how much display area to devote to each of the product categories. Increasing the display area for any one product category tends to increase the sales of that product category, although generally with diminishing returns as the display area becomes relatively large; and increasing the display area for any one product category necessarily decreases the display area available for another product category. Planning how much merchandising display area to devote to each product category poses a difficult challenge.

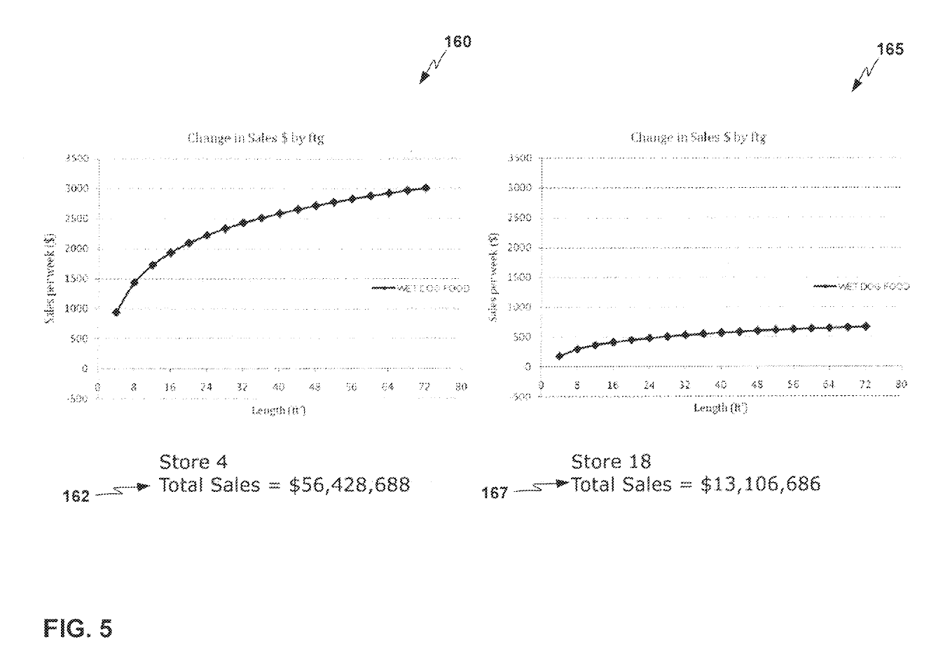

FIG. 5 shows graphs of sales as a function of merchandising display area for a selected product category, at each of two different retail stores. FIG. 5 gives an indication of the increase in sales as a function of the increase in merchandising display area for a given product category, with diminishing returns as the display area becomes relatively large. Graph 160 shows sales, in terms of revenue for the product category per week at a first retail store (i.e. “Store no. 4”), as a function of merchandising display area, in terms of the length of merchandising space (in increments of four foot wide planogram sections, and at a fixed height) for a selected product category, i.e. a “wet dog food” product category. The sales per week per display area range from just under $1,000 for a four-foot-wide display area, to about $3,000 for a seventy-two-foot-wide display area. Caption 162 shows the total annual revenue for Store no. 4, of $56,428,688, which serves as a general indicator of this particular store's size and a basis of comparison for the sales of one particular product category, such as wet dog food.

Graph 165 shows sales for the same product category per week as a function of merchandising display area, at a second, smaller retail store (i.e. “Store no. 18”) that has lower overall revenues. Sales per unit of display area (e.g., per four-foot-wide planogram section, with a fixed height) for the “wet dog food” product category are shown for this store again in terms of sales per week per length of display area. Caption 167 shows the total annual revenue for Store no, 18, of $13,106,686, or about 23% of the annual revenue for Store no. 4 shown in graph 160. This corresponds closely with the difference in the sales per week per display area between the two stores, with the levels for Store no. 18 generally close to 23% of those for Store no. 4 at each point along the curves shown in graphs 160 and 165, i.e. for each increment of a four-foot wide planogram section of merchandising display area at each of the two stores.

Graphs 160 and 165 demonstrate the diminishing returns of increasing the merchandising display area for a given product category. In the case of graph 160 (in which the larger total sales make the effect easier to see), while the first four feet of display area width account for about $1,000, the next increase from four feet to eight feet of display area width increases sales by about $500 to about $1,500, while it takes another eight feet of increase to a total of sixteen feet of width to increase sales another $500 to about $2,000. Increasing sales yet another $500 is not achieved until display area is increased to thirty-six feet, while the display area must be doubled again from there to seventy-two feet to extend sales yet another $500 to about $3,000. In this situation, while the first four feet of display area account for $1,000 of sales, the last thirty-six feet account for only $500 of sales.

In a simplified situation in which a fixed total of seventy-two feet of merchandising display area must be divided in a merchandising plan among just two product categories that each have an identical function of sales per display area as depicted in graph 160, from a starting point in which all seventy-two feet are devoted to just one of the product categories, just switching the first four feet of display area from the first category to the second would decrease sales of the first category by only around $100, while it would introduce sales of the second category of about $1,000. The merchandising plan in this simplified situation would be optimized by dividing the display area of seventy-two feet equally between the two product categories, with thirty-six feet of display area assigned to each of the two product categories. In this case, instead of all seventy-two feet of display area being assigned to the first product category and generating about $3,000 in sales per week, thirty-six feet of display area are assigned to each of the two product categories, each of which generate about $2,500 in sales per week, for a total of about $5,000 in sales per week for the same seventy-two feet of merchandising display space, i.e. a 60% increase in sales over the initial conditions.

This example is greatly simplified in that it only considers two product categories rather than tens or hundreds or thousands, and in that it assumes that the function of sales per unit of display area is identical for each product category. However, this example demonstrates the real value of increasing sales by optimizing how much merchandising display area to assign to each product category. Devising a merchandising plan that optimizes the allocation of merchandising display area assigned to each of a plurality of product categories that may include tens, hundred, thousands, or any number of product categories poses a substantial challenge, one that is addressed by systems of the present disclosure.

To optimize the merchandising area for each product category also requires defining what is to be optimized. The example discussed above makes reference to optimizing for total sales revenue, which is one illustrative example of a financial metric that may be selected as the basis on which to optimize the allocation of merchandising area for the product categories. A merchandising plan may also be formulated to optimize for other financial metrics besides sales revenue, such as net profits or unit sales, for example. In one illustrative example, total revenue may be selected as the financial metric for many product categories that are more or less low margin commodity items. Unit sales may be selected for product categories that have low margins but which are in constant demand and are deemed valuable to keep always available, so that customers can rely on always finding them at a store of the retail enterprise. Net profits may be selected for product categories that generally have higher margins. In other examples, other strategies may be applied for selecting different financial metrics for different product categories, and still other financial metrics may be defined and applied to various product categories. Total sales revenue may also be referred to as gross revenue, and net profits may also be referred to as gross margin, for purposes of this disclosure.

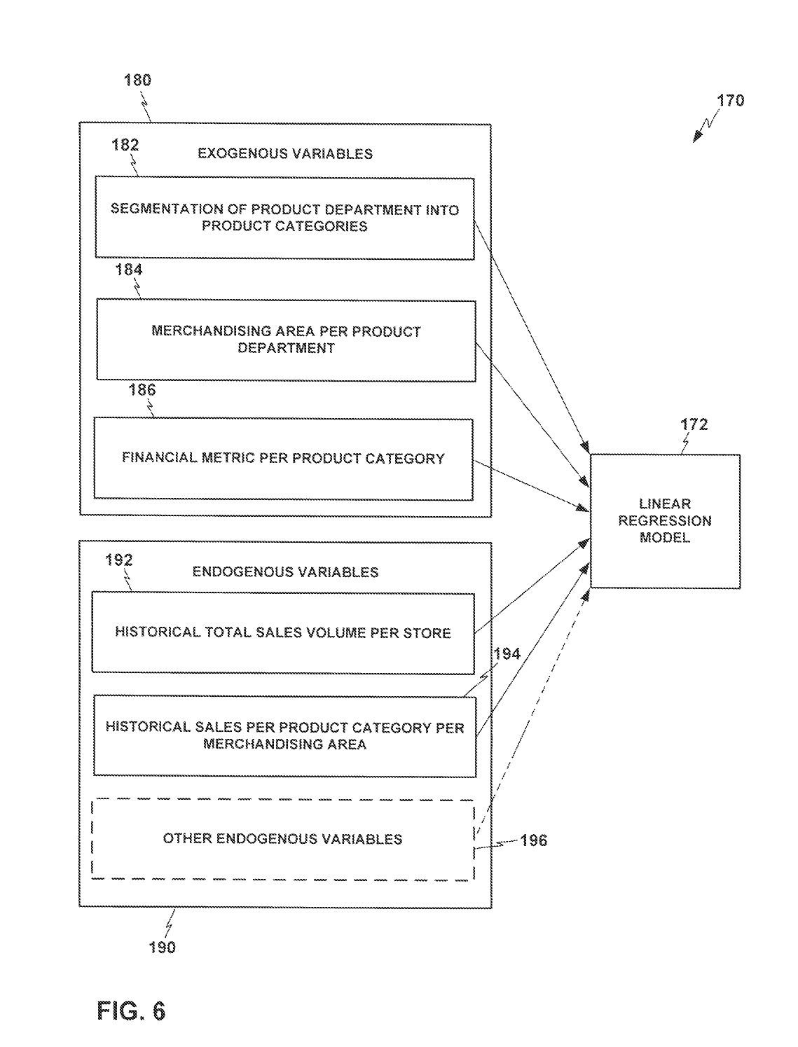

FIG. 6 shows a block diagram of a system 170 for generating merchandising plans for a product department that optimizes the allocation of merchandising area among the various product categories in the product department to optimize the financial metrics of the product categories. In particular, FIG. 6 is a block diagram of for an adjacency optimization system 170, or product category merchandising area allocation optimization system 170, that includes exogenous variables 180 and endogenous variables 190 that are provided to a linear regression model 172, in accordance with aspects of this disclosure. The exogenous variables 180 and endogenous variables 190 may be encoded or provided as data, and the linear regression model 172 may be embodied as an algorithm or software package that receives and processes the data of exogenous variables 180 and endogenous variables 190, in one illustrative example.

Exogenous variables 180 include variables that a user has power to select or to vary. Endogenous variables 190 include historical data or otherwise pre-determined data that are used in combination with exogenous variables 180 as a basis for modeling or forecasting the desired output of linear regression model 172, such as a merchandising plan for a product department that includes an optimized allocation of merchandising area for each of the product categories in the product department. This may include linear regression model 172 forecasting responses of the financial metrics per product category 186 to the endogenous variables, and optimizing by maximizing the total response of the financial metrics to the allocation of merchandising area to the various product categories. The exogenous variables 182 may also include an indication of the amount of merchandising area currently assigned to each of the product categories, and the output of system 170 may include indications of changes in merchandising area for each of the product categories, that is, the amount of area by which to change the area assigned to each of the product categories.

As shown in FIG. 6, the endogenous variables 190 include historical sales per product category per merchandising area 194, such as is shown in graphs 160 and 165 of FIG. 5, and historical total sales volume per store 192, such as is shown at 162 and 167 in FIG. 5. In various examples, endogenous variables 190 may consist only of the historical sales per product category per merchandising area 194 for each of a plurality of retail stores, and the historical total sales volume per store 192 for each of the plurality of stores. In various examples, the endogenous variables 190 for providing to the linear regression model 172 may also include variables such as a geographical region, a neighborhood affluence level, a parking lot size, or a measure of visibility and accessibility from major roads, for example.

A user may also enter or provide data for exogenous variables 180 or arrange for system 170 to receive exogenous variables 180 from any appropriate data source or computing resource. Exogenous variables 180 may for example include segmentation of a product department into product categories (182), e.g. which individual products are grouped into which categories; merchandising area per product department (184), e.g., the total area in any particular store assigned to a given product department, and which may for example be counted in terms of a number of four-foot-wide merchandising sections; and the financial metric per product category (186). The financial metric per product category may include gross revenue, gross margin, unit sales, or a proportional combination of two or all three of these, or may include another financial metric.

Linear regression model 172 may use the exogenous variables 180 and the endogenous variables 190 and maximize the total response of the financial metrics to the allocation of merchandising area to the various product categories, and generate a corresponding merchandising plan that optimizes the allocation of merchandising area for each of the product categories in the product department. System 170 may also compare the optimized allocation of merchandising area per product category with the current or pre-existing merchandising area per product category, to determine the difference in merchandising area per product category between pre-existing and optimized, and generate an output that indicates the change in merchandising area to make for each of the product categories.

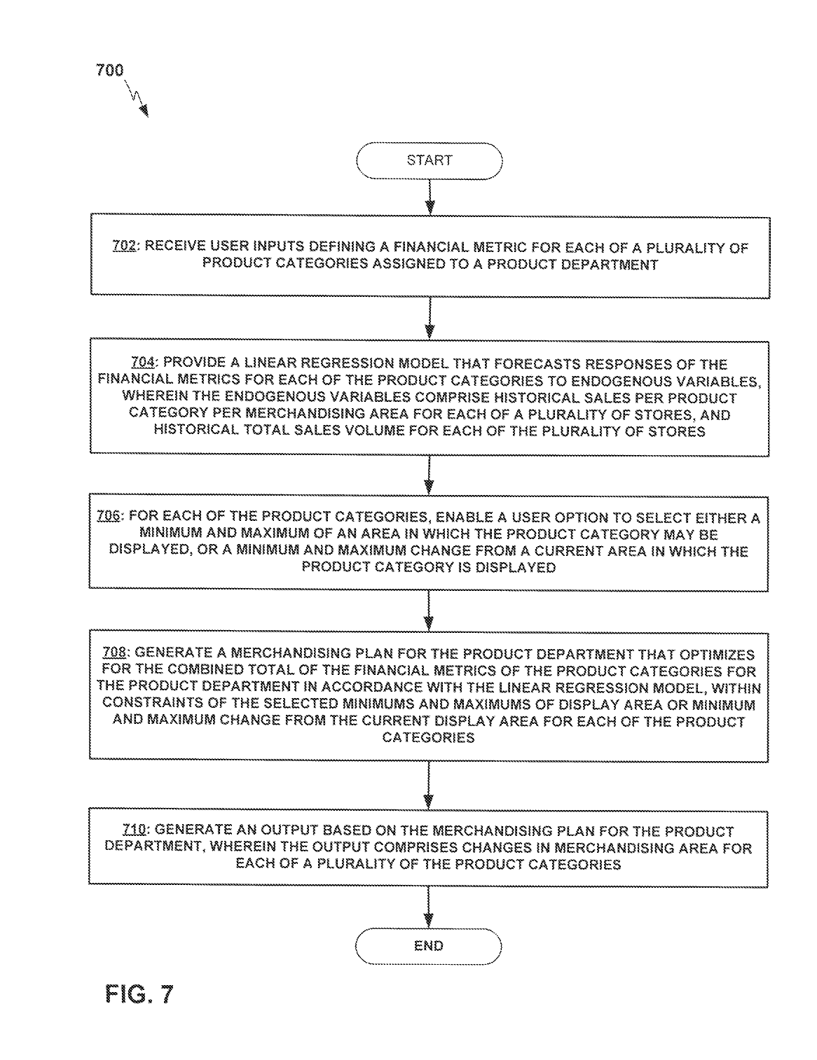

FIG. 7: Example Method of Operation

FIG. 7 is a flowchart illustrating an example method 700 of an adjacency optimization system of this disclosure, such as adjacency optimization system 10 of FIG. 1 and the various aspects depicted in the other figures and described herein, to generate an optimized product merchandising plan determining an allocated merchandising area per product category. By performing method 700, elements of an adjacency optimization system may generate a merchandising plan for a product department and generate outputs based on the merchandising plan. Method 700 may illustratively be discussed in terms of operations or functions performed by a device, such as computing device 12 as described above with reference to FIG. 1, which may execute software for an adjacency optimization system 170 that includes a linear regression model 172 as depicted and described with reference to FIG. 6.

in performing method 700, a computing device may receive user inputs defining a financial metric for each of a plurality of product categories assigned to a product department (702). A computing device may provide a linear regression model that forecasts responses of the financial metrics for each of the product categories to endogenous variables, wherein the endogenous variables comprise historical sales per merchandising area per product category for each of a plurality of stores, and historical total sales volume for each of the plurality of stores (704). For each of the product categories, a computing device may enable a user option to select either a minimum and maximum of an area in which the product category may be displayed, or a minimum and maximum change from a current area in which the product category is displayed (706). A computing device may generate a merchandising plan for the product department that optimizes for the combined total of the financial metrics of the product categories for the product department in accordance with the linear regression model, within constraints of the selected minimums and maximums of display area or minimum and maximum change from the current display area for each of the product categories (708). A computing device may also generate an output based on the merchandising plan for the product department, wherein the output comprises changes in merchandising area for each of a plurality of the product categories (710).

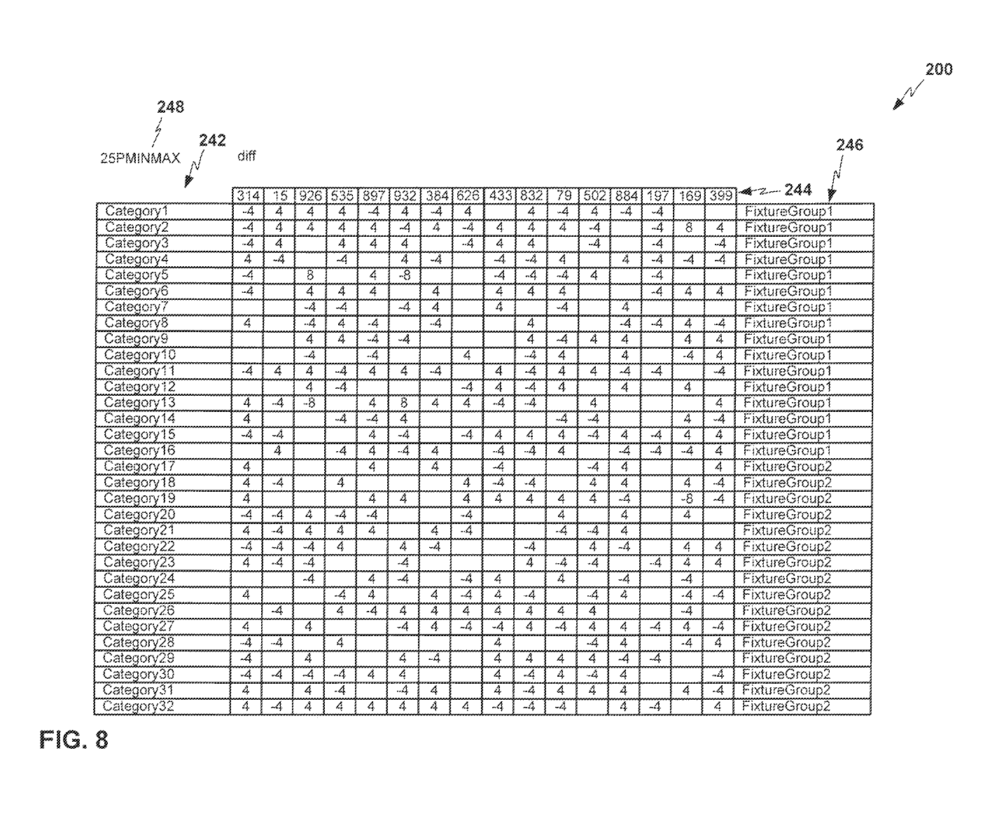

FIG. 8 depicts a merchandising area change spreadsheet 200 as an output based on a merchandising plan for a product department in accordance with an example of this disclosure using example data. An adjacency optimization system such as system 10 of FIG. 1 or system 170 of FIG. 6 may generate merchandising area change spreadsheet 200 as a result of running an optimization of merchandising area per product category using linear regression model 172 of FIG. 6. System 170 may compare the optimized allocation of merchandising area per product category with the current or pre-existing merchandising area per product category, to determine the difference in merchandising area per product category between pre-existing and optimized, and generate an output that indicates the change in merchandising area to make for each of the product categories. Merchandising area change spreadsheet 200 therefore shows changes in merchandising area for each of a plurality of the product categories in a product department.

In this particular example, spreadsheet 200 shows increments of either positive or negative four feet in width by which to change the merchandising area for each of several product categories in each of a number of stores. The product categories are individually listed in column 242, and store ID numbers for a number of stores are listed in top row 244, so that each unit in the spreadsheet shows the recommended change in merchandising area for the particular product category listed in column 242 at each of the retail stores listed in top row 244. The recommended changes in merchandising area may be based on the results of the linear regression model based on endogenous variables such as the historical sales per product category per unit of merchandising area for each of the product categories listed in column 242, and historical total sales volume per store for each of the stores listed in top row 244.

Output 200 also includes column 246 that shows a fixture group to which each of the product categories listed in column 242 belongs. Output 200 also shows a user-selected option at 248 for changes in merchandising area to be limited to at most 25% as a minimum or maximum change, indicated at 248 as “OPTION: 25PMINMAX”. This option may be presented to a user as a way of limiting the volume of changes in product placement in the available merchandising area at one time. This may be an advantageous option in some cases where a user may want to balance a pragmatic concern for the effort of how much volume of product placement changes are made at one time with the optimization of the merchandising area allocation per product category. Other user-selectable options for attenuating or modifying the changes that might be recommended by the adjacency optimization system may also be provided.

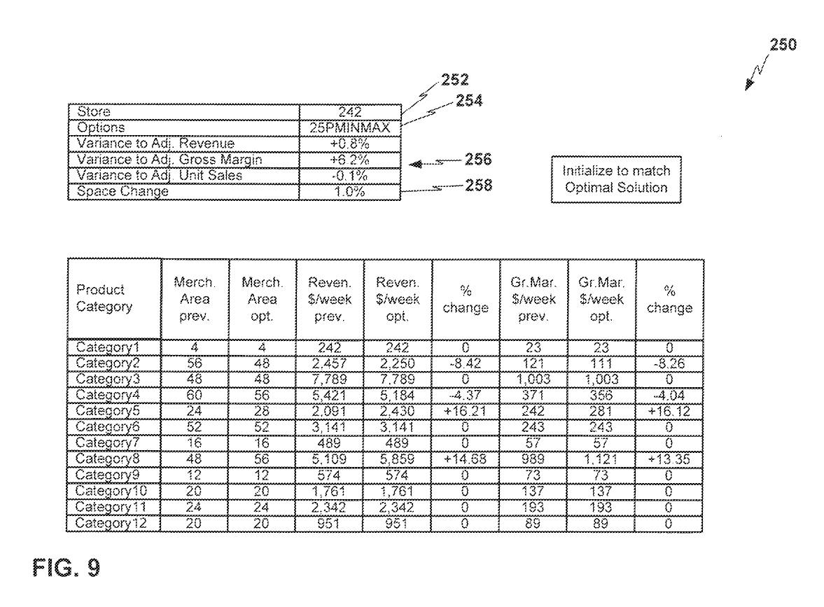

FIG. 9 depicts an output 250 based on a merchandising plan for a product department in accordance with an example of this disclosure using example data. Output 250 is for one particular retail store, indicated by a store ID number 252, and with a user-selected option 254 of “25PMINMAX” as explained above. Output 250 includes financial metric variance indications 256 that show the total variance in each of the considered financial metrics involved, or how the financial metrics are predicted to change based on the implementation of the recommended changes in merchandising area allocated to each of the product categories. As shown in FIG. 9, this includes a variance to adjusted sales (or total sales revenue) of positive 0.8%, a variance to gross margin of positive 6.2%, a variance to unit sales of negative 0.1%. Output 250 also includes an indication 258 of the total space change, or the total proportion of the merchandising area that is subject to a change of product category, of 1.0%. Therefore, as output 250 shows, the adjacency optimization system is able to generate a predicted 6.2% increase in gross margins, i.e. in net profits, by changing the product category assignments of just 1.0% of the merchandising area of the store.

The bulk of output 250 includes a spreadsheet showing details of product departments, product categories, the initial merchandising area assigned to each of the product categories, the recommended change made to the merchandising area of each of the product categories under different user-selected options or without restriction by any options, previously recorded financial performance of each of the product categories under each of a few different financial metrics, the predicted performance under the financial metrics under the recommended changes in merchandising area for each of the product categories, and related data. Output 250 as shown in FIG. 9 is a representative example of what may include additional columns of data for each product category; and which may include a large number of additional product categories.

As output 250 shows, the product category merchandising optimization plan raises the merchandising area assignments for certain product categories the application has identified as having a relatively steep curve in financial metrics (particularly gross margin) for incremental change in merchandising area. The product category merchandising optimization plan also reduces the merchandising area assignments for certain product categories the application has identified as having a relatively flat curve in financial metrics (particularly gross margin) for incremental change in merchandising area. As output 250 further shows, the product category merchandising optimization plan ends up reducing the merchandising area assigned to certain lower-margin product categories and increasing the merchandising area assigned to certain higher-margin product categories in a way that helps optimize total gross margins.

This optimization may be done in a linear regression model that optimizes for gross margins as the only financial metric applicable to each of the product categories, or as the financial metric carrying the highest weight in a weighted combination of financial metrics sought to be optimized. This optimization may also include applying different financial metrics or financial metric weights to each product category individually; and optimizing for a total combined result that balances optimization for the individually applicable financial metrics for each product category, in various examples.

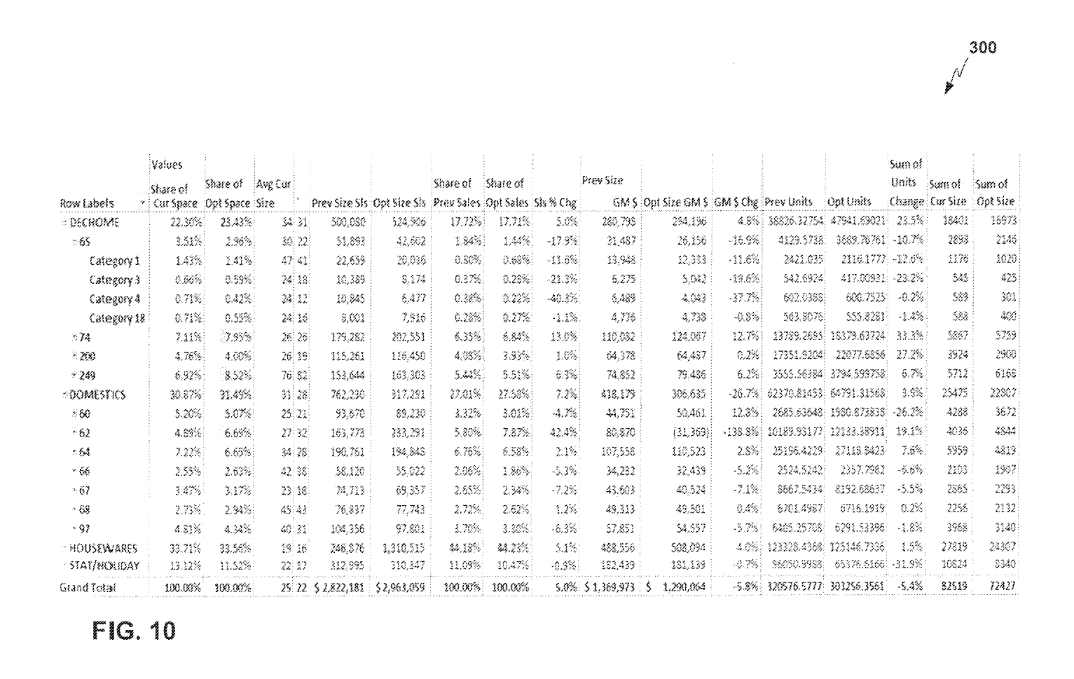

FIG. 10 depicts an output 300 based on a merchandising plan for a product department in accordance with an example of this disclosure using example data. Output 300 shows another spreadsheet with a different view of data for various product categories comparing the share of current space i.e. merchandising area for each category, the share of optimum space, various data on recorded performance and predicted performance by each of a number of financial metrics, and data on how much the merchandising area is changed according to the output of the adjacency optimization system.

Various options may be used by the adjacency optimization system and may be provided as user-selected options in some embodiments. One option may include supplementing the linear regression model with a piecewise linear regression model for one or more product categories in one or more stores. In this case, defining the selected financial metrics for the product categories may include substituting a forecast by the linear regression model for one or more product categories in one or more stores for which there is below a selected threshold level of data for at least one of the historical sales per product category per merchandising area for each of a plurality of stores, and historical total sales volume for each of the plurality of stores. In other words, for stores that are new and don't have sufficient data on historical sales volume, or for product categories that don't have a large set of historical data for how sales vary as a function of merchandising area, such as if a product category has been kept at a relatively constant merchandising area or has only recently been defined, piecewise substitutes may be made in a model in place of linear regression modeling.

In another option, the linear regression model is based on the predicted sales of a product category in a given store being modeled as a product of the natural logarithm of a merchandising area for the product category times a conversion factor, times a sum of a first constant plus a second constant times a sales volume for the given store. The natural logarithms, conversion factors, and constants may be matched to the data for each product category in each store for which data is available, such as the sales data depicted in FIG. 5. An illustrative example of an equation that may be used in a linear regression model for predicting sales in a given product category is given in Equation 1:

$$CategorySales = [ \begin{matrix}Intercept + \\ ( \begin{matrix}SlopeLength + SlopeMixed * \\ SalesVolume\end{matrix} ) * C * ln ( Area )\end{matrix} ] \qquad ( Eq . 1 )$$

In this example, CategorySales is a variable representing the sales of a product category in a given store as predicted by the equation; Area is a variable representing a merchandising area assigned to a product category, which may be measured in the length in feet of store aisle space devoted to the category, for example; SalesVolume represents recorded data for the total sales volume for the given store; C represents a conversion factor that may be fitted to data to convert the merchandising area from its original units of measurement to match the generally logarithmic slopes of category sales per unit of merchandising area assigned to a product category; SlopeLength represents the variation in product category sales per unit of merchandising area, incorporating the historical sales per merchandising area per product category for each of a plurality of stores; and SlopeMixed is a variable that may be fitted to recorded data to incorporate the variation in product category sales based on the total sales volume for the given store. The product of SlopeMixed times SalesVolume therefore incorporates the historical relationship of how category sales vary for total sales volume for each of the plurality of stores. Intercept is an additional factor that, in different examples, may or may not be added to the product of the other factors to match recorded data. The concept of Equation 1 may be restated with generic variable names as in Equation 2:

S=[C1+(x+y*V)*C2*ln(A)] (Eq. 2)

In Equation 2, S represents the predicted product category sales, C1 represents the “Intercept” factor, C2 represents the conversion factor, x represents a first variable, i.e. “SlopeLength” in the example of Equation 1, y represents a second variable, i.e. “SlopeMixed” in the example of Equation 1, V represents total store sales volume, and A represents the merchandising area. A linear regression model may therefore use an equation such as Equation 1 or Equation 2 to forecast predicted product category sales for each of a number of product categories, based on a product of the natural logarithm of a merchandising area for the product category (e.g., ln(Area), ln(A)), times a sum of a first endogenous variable that incorporates historical variation in sales per merchandising area per product category for each of a plurality of stores (e.g., SlopeLength, x), plus a sales volume for the given store (e.g., SalesVolume, V), times a second endogenous variable that incorporates a variation in product category sales based on a total sales volume for a given store (e.g., SlopeMixed, y), according to some illustrative examples.

Another option may include optimizing for the combined total of the mixed sales metrics for the product department in accordance with the linear regression model, within constraints of specific fixture types for the product categories. For example, a store may have different types of merchandising area fixtures such as shelves, racks, refrigerator sections, and so forth, and particular products may be limited to being merchandised in particular fixture types, without a more substantial revision of the store's arrangement of merchandising fixtures. In this case, the products and the merchandising areas may be separated according to the fixture types that go with particular products.

In another option, the financial metric thr each of the product categories comprises a mixed sales metric selected for each of the product categories, wherein the mixed sales metric defines a proportion in which sales of the product category are to optimize for one or more of: unit sales, gross sales, and gross margin. A given product category may be optimized purely for one of these metrics, or for a combination of metrics, such as 50% for gross sales and 50% for gross margin, or some other combination of the metrics, based on business criteria for the particular product category. In another option, generating the merchandising plan for the product department may also include optimizing within constraints of selected merchandising display criteria, comprising rules or strategies for the merchandising display of the product categories. For example, merchandising criteria may be applied for certain products that should or should not be displayed adjacent or proximate to each other, and such display criteria may be included as added constraints or logical rules in developing the merchandising plan.

Another option may include collecting sales data for a product department that has been merchandised in accordance with the merchandising plan; measuring a correlation of the collected sales data against the forecasts of the linear regression model; and revising the linear regression model based on the collected sales data. This may serve as an important check on the predictive accuracy of the linear regression model. If future sales end up diverging from the prediction of the linear regression model, the model may be re-evaluated and modified. On the other hand, if future sales end up within the prediction of the linear regression model, this can serve as an important validation of the model, and its continued accuracy may be monitored and studied for application across other product categories.

In another option, generating the output based on the merchandising plan for the product department may further include providing a predicted change in sales for each of the product categories. In another option, generating the output based on the merchandising plan for the product department may further include providing a predicted change in margin for each of the product categories. Examples of these predicted changes in sales and margins per product category are shown in FIGS. 9 and 10. Tracking future performance of these particular performance metrics against the predictions may also serve as useful indicators of the predictive accuracy of the linear regression model across a range of metrics. Other options may also be used or provided in other examples.

In another example, an adjacency optimization application may also provide options for a user to manually adjust the merchandising area assigned to each product category away from the optimization results of an optimized merchandising plan output, and for the adjacency optimization application to generate predictions for the financial metrics resulting from those manual modifications. The adjacency optimization application may display or enable comparisons between predicted financial metric results from the generated optimization results and predicted financial metric results from the manually modified product category merchandising areas. This manual adjustment feature, or “what if” feature, may also be based on a linear regression model.

If a business user has additional criteria or constraints in mind that are not accounted for in the adjacency optimization application, the business user may use this manual adjustment feature to explore how different manual adjustments to the product category merchandising areas affect the predicted sales, profits, margins, or other financial metrics or weighted combination of financial metrics sought to be optimized. This manual exploration mode of various manual adjustments may enable a user to discover variations on the optimized results for the product merchandising areas that may yield financial metric results that differ only very gradually or very slightly from the optimized financial metric results associated with the optimized merchandising area set. The manual exploration mode may, for example, be implemented in a spreadsheet of product category merchandising area changes similar to spreadsheet 200 as depicted in FIG. 8, in which the user may manually change the values in the spreadsheet, and the adjacency optimization application may then display the financial metric results of the adjusted values, as well as metrics of comparison between the manual adjustment results and the originally generated optimized results.

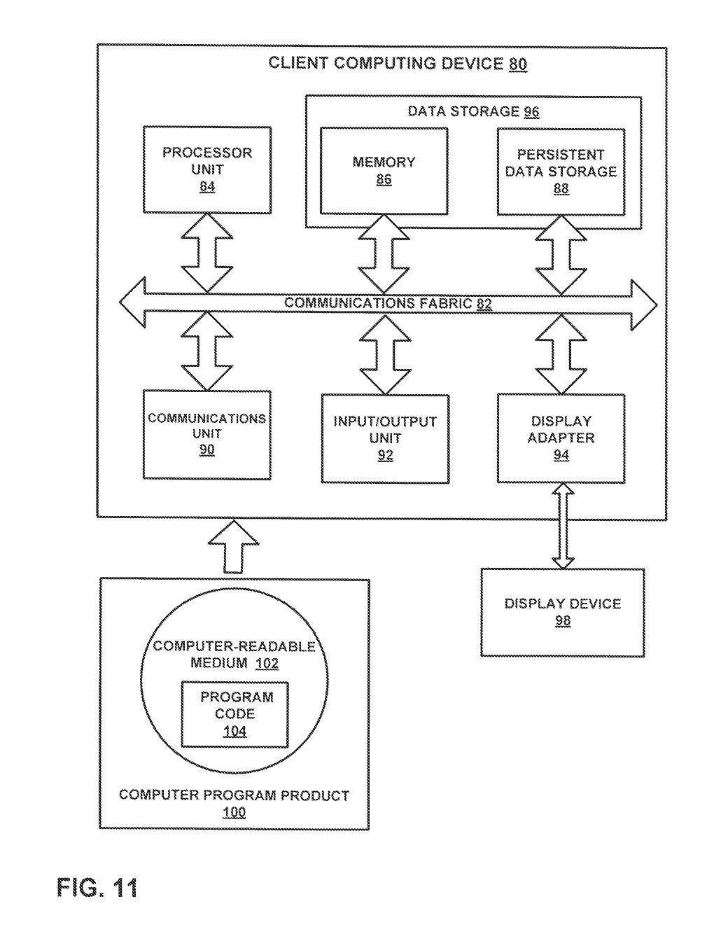

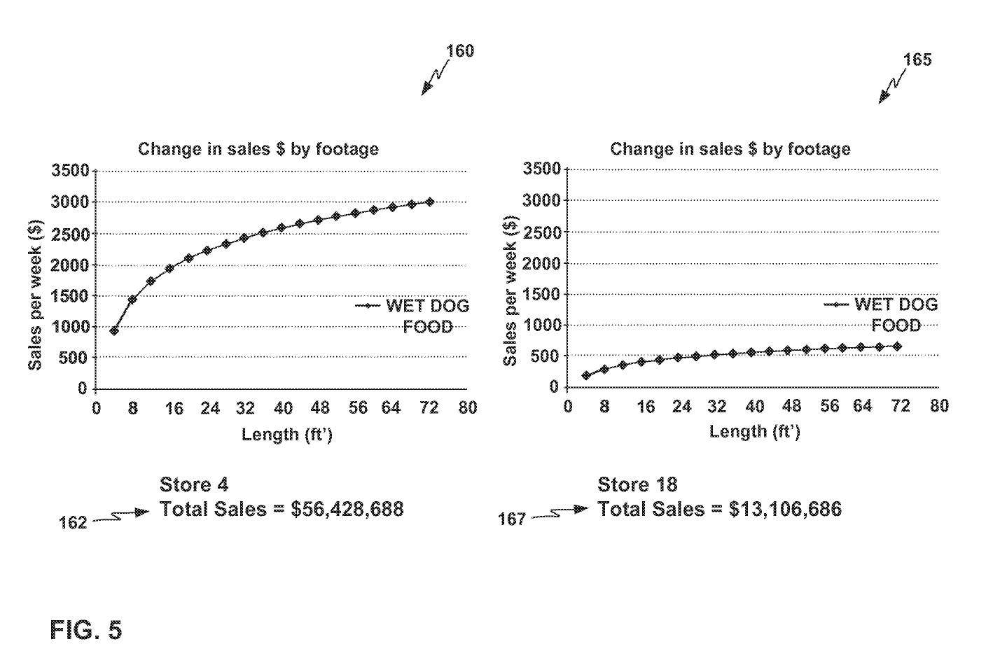

FIG. 11 is a block diagram of a computing device 80 that may be used to run a client user interface for an adjacency optimization system, such as computing device 12 as part of adjacency optimization system 10 of FIG. 1, in accordance with aspects of this disclosure. FIG. 11 provides details of how client computing device 12 of FIG. 1 may provide part of the basis for the functioning of adjacency optimization system 10. An adjacency optimization system may be enabled to perform automated adjacency optimization, i.e. optimizing allocation of merchandising area among various product categories, either by incorporating this capability within a single application, or by making calls and requests to and otherwise interacting with any of a number of other modules, libraries, data access services, indexes, databases, servers, or other computing environment resources, including one or more implementations of computing device 80, thr example. Computing device 80 may be a workstation, server, mainframe computer, notebook or laptop computer, desktop computer, tablet, smartphone, feature phone, or other programmable data processing apparatus of any kind. Other possibilities for computing device 80 are possible, including a computer having capabilities or formats other than or beyond those described herein.

In this illustrative example, computing device 80 includes communications fabric 82, which provides communications between processor unit 84, memory 86, persistent data storage 88, communications unit 90, input/output (I/O) unit 92, and display adapter 94. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor, an x86 compatible processor, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity in FIG. 11, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, but those skilled in the art will recognize that this also constitutes an example of a physical, tangible, non-transitory computer-readable data storage device. Executable instructions are stored on anon-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for an application for optimizing merchandising area allocation among various product categories, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below. The operating system may provide functions such as device interface management, memory management, and multiple task management. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. Some of these examples may overlap with each other, or with example components of communications unit 90 or data storage 96. Input/output unit 92 may also include appropriate device drivers for any type of external device, or such device drivers may reside in the operating system or elsewhere on computing device 80 as appropriate.

Computing device 80 may also include a display adapter 94 in this illustrative example, which provides one or more connections for one or more display devices. Input/output unit 92 may also include appropriate device drivers for any type of external device, or such device drivers may reside in the operating system or elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be connected to display adapter 94 and may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, Blu-Ray disc, a magnetic disc, a USB stick, a flash drive, or an external hard disc drive, as illustrative examples, or any other suitable data storage technology. Computer program code 104 may include an application for optimizing merchandising area allocation among various product categories, as described in greater detail above.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84. The physical program code signal thereby physically causes processor unit 84 to generate physical outputs that correspond to the computer-executable instructions, in a way that modifies computing device 80 into a new physical state and causes computing device 80 to physically assume new capabilities that it did not have until its physical state was changed by loading the executable instructions comprised in program code 104.

In some illustrative examples, program code 104 may be downloaded over a network to data storage 96 from another device or computer system, such as a server, for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located on a separate computing asset at a separate or remote location from computing device 80, and may be located anywhere, including at any remote geographical location anywhere in the world, and may relay program code 104 to computing device 80 over any type of one or more communication links, such as the Internet and/or other packet data networks, and may then be implemented by or embodied by computing device 80, regardless of the geographical location of a computing asset from which program code 104 originated. The program code 104 may be transmitted over a wireless Internet connection, or over a shorter-range direct wireless connection such as wireless LAN, Bluetooth™, Wi-Fi™, or an infrared connection, for example. Any other wireless or rewrote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

Aspects of this disclosure may be embodied as a method, a computing system, or a computer program product, for example. Accordingly, aspects of this disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, aspects of the present invention may take the form of a computer program product embodied in one or more computer-readable data storage devices or computer-readable data storage components that include computer-readable medium(s) having computer readable program code embodied thereon. For example, a computer-readable data storage device may be embodied as a tangible device that may include a tangible, non-transitory data storage medium, as well as a controller configured for receiving instructions from a resource such as a central processing unit (CPU) to retrieve information stored at one or more particular addresses in the tangible, non-transitory data storage medium, and for retrieving and providing the information stored at those particular one or more addresses in the data storage medium.

The data storage device may store information that encodes both instructions and data, for example, and may retrieve and communicate information encoding instructions and/or data to other resources such as a CPU, for example. The data storage device may take the form of a main memory component such as a hard disc drive or a flash drive in various embodiments, for example. The data storage device may also take the form of another memory component such as a RAM integrated circuit or a buffer or a local cache in any of a variety of forms, in various embodiments. This may include a cache integrated with a controller, a cache integrated with a graphics processing unit (GPU), a cache integrated with a system bus, a cache integrated with a multi-chip die, a cache integrated within a CPU, or the processor registers within a CPU, as various illustrative examples. The data storage apparatus or data storage system may also take a distributed form such as a redundant array of independent discs (RAID) system or a cloud-based data storage service, and still be considered to be a data storage component or data storage system as a part of or a component of an embodiment of a system of the present disclosure, in various embodiments.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, electro-optic, heat-assisted magnetic, or semiconductor system, apparatus, or device, or any suitable combination of the foregoing. A non-exhaustive list of additional specific examples of a computer readable storage medium includes the following: an electrical connection having one or more wires, a portable computer diskette, a hard disc, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device, for example.

Program code embodied on a computer readable medium may be transmitted using any appropriate medium, including but not limited to radio frequency (RF) or other wireless, wireline, optical fiber cable, etc., or any suitable combination of the foregoing. Computer program code for carrying out operations for aspects of the present invention may be written in any of one or more programming languages, such as Java, C, C++, C#, Python, Ruby, Scala, or Clojure, among a variety of illustrative examples. One or more sets of applicable program code may execute partly or entirely on the user's desktop or laptop computer, tablet, or other computing device; as a stand-alone software package, partly on the user's computing device and partly on a remote computing device; or entirely on one or more remote servers or other computing devices, among various examples. In the latter scenario, the remote computing device may be connected to the user's computing device through any type of network, including a local area network (LAN) or a wide area network (WAN), or the connection may be made to an external computer (for example, through a public network such as the Internet using an Internet Service Provider), and for which a virtual private network (VPN) may also optionally be used.

In various illustrative embodiments, various computer programs, software applications, modules, or other software elements may be executed in connection with one or more user interfaces being executed on a client computing device, that may also interact with one or more web server applications that may be running on one or more servers or other separate computing devices and may be executing or accessing other computer programs, software applications, modules, databases, data stores, or other software elements or data structures.

A graphical user interface may be executed on a client computing device and may access applications from the one or more web server applications, for example. Various content within a browser or dedicated application graphical user interface may be rendered or executed in or in association with the web browser using any combination of any release version of HTML, CSS, JavaScript, XML, AJAX, JSON, and various other languages or technologies. Other content may be provided by computer programs, software applications, modules, or other elements executed on the one or more web servers and written in any programming language and/or using or accessing any computer programs, software elements, data structures, or technologies, in various illustrative embodiments.

An application for optimizing merchandising area allocation among various product categories or portions thereof may be referred to as “modules” in the most generic sense that they are portions of machine-readable code in any form, and are not limited to any particular form or particular type of machine-readable code. For example, this may include a stand-alone application, or may be implemented as one or more modules, methods, classes, objects, libraries, subroutines, or other portions of machine-readable code as part of a larger application. In still other examples, the capabilities or functions of the application as described herein may be included in a new patch or upgrade to existing software that may already have been loaded on computing device 80 but that previously lacked such capabilities or functions.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices, to produce a computer implemented process such that the instructions which execute on the computer or other programmable apparatus provide or embody processes for implementing the functions or acts specified in the flowchart and/or block diagram block or blocks.

The flowchart and block diagrams in the figures illustrate the architecture, functionality, and operation of possible implementations of devices, methods and computer program products according to various embodiments of the present disclosure. In this regard, each block in the flowchart or block diagrams may represent a module, segment, or portion of code, which includes one or more executable instructions for implementing the specified logical function(s). In some implementations, the functions noted in the block may occur out of the order noted in the figures. For example, two blocks shown in succession may, in fact, be executed substantially concurrently, or the blocks may be executed in a different order, or the functions in different blocks may be processed in different but parallel threads, depending upon the functionality involved. Each block of the block diagrams and/or flowchart illustration, and combinations of blocks in the block diagrams and/or flowchart illustration may be implemented by special purpose hardware-based systems that perform the specified functions or acts, or combinations of special purpose hardware and computer instructions.

Aspects of this disclosure may be equally applicable and implemented in any browser or operating system, and using any other APIs, frameworks, or toolsets. Aspects described herein for transmission, decoding, and rendering of data for video output or video content, which may be considered interchangeably herein with media output or media content that also includes audio output or audio content, may make use of any protocol, standard, format, codec, compression format, HTML element, or other technique or scheme for encoding, processing, decoding, rendering, or displaying an audio output or a video output.

Various techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In various examples, an article of manufacture may comprise one or more computer-readable storage media.

In various examples, the data storage devices and/or memory may comprise computer-readable storage media that may comprise non-transitory media. The term “non-transitory” may indicate that the storage medium is not embodied in a carrier wave or a propagated signal. In certain examples, anon-transitory storage medium may store data that can, over time, change (e.g., in RAM or cache). Machine-readable code may be stored on the data storage devices and/or memory, and may include executable instructions that are executable by at least one processor. “Machine-readable code” and “executable instructions” may refer to any form of software code, including machine code, assembly instructions or assembly language, bytecode, software code in C, or software code written in any higher-level programming language that may be compiled or interpreted into executable instructions that may be executable by at least one processor, including software code written in languages that treat code as data to be processed, or that enable code to manipulate or generate code. Various techniques described herein may be implemented in software that may be written in any of a variety of languages, making use of any of a variety of toolsets, frameworks, APIs, programming environments, virtual machines, libraries, and other computing resources, as indicated above. For example, software code for implementing various aspects of this disclosure may be written in Java, C, C++, Python, Ruby, Scala, Clojure, or any other language.

In various examples, an application for optimizing merchandising area allocation among various product categories may be written in Java and be configured to provide content in JavaScript in a user's browser on a client computing device. For example, the web application may include functionality to generate HTML in Java and JavaScript, and to access JavaScript libraries for supporting DOM and AJAX functions in the browser of the client computing device. In other examples, all or portions of the web application may also be written in Python, Ruby, Clojure, or any other programming language. In other examples, an application for optimizing merchandising area allocation among various product categories may run directly on a client computing device.

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor” as used herein may refer to any of the foregoing structure or any other structure suitable for implementation of the techniques described herein. In addition, in some aspects, functionality described in this disclosure may be provided within software modules or hardware modules.

Various examples have been described. These and other examples are within the scope of the following claims.

What is claimed is:

1. A method of using a computing system for generating an optimized product merchandising plan determining an allocated merchandising area per product category, the method comprising:
receiving user inputs defining a financial metric for each of a plurality of product categories assigned to a product department;
providing a linear regression model that forecasts responses of the financial metrics for each of the product categories to endogenous variables, wherein the endogenous variables comprise historical sales per merchandising area per product category for each of a plurality of stores, and historical total sales volume for each of the plurality of stores;
generating a merchandising plan for the product department that optimizes for the combined total of the financial metrics of the product categories for the product department in accordance with the linear regression model, within constraints of the selected minimums and maximums of display area or minimum and maximum change from the current display area for each of the product categories; and
generating an output based on the merchandising plan for the product department, wherein the output comprises changes in merchandising area for each of a plurality of the product categories.

2. The method of claim 1, further comprising:
for each of the product categories, enabling a user option to select either a minimum and maximum of an area in which the product category may be displayed, or a minimum and maximum change from a current area in which the product category is displayed; and
wherein generating the merchandising plan for the product department comprises optimizing for the combined total of the financial metrics of the product categories for the product department in accordance with the linear regression model, within constraints of the selected minimums and maximums of display area or minimum and maximum change from the current display area for each of the product categories.

3. The method of claim 1, further comprising:
supplementing the linear regression model with a piecewise linear regression model for one or more product categories in one or more stores, wherein defining the financial metrics for the product categories comprises substituting a forecast by the linear regression model for one or more product categories in one or more stores for which there is below a selected threshold level of data for at least one of the historical sales per merchandising area per product category for each of the plurality of stores, and historical total sales volume for each of the plurality of stores.

4. The method of claim 1, in which the linear regression model is based on the predicted sales of a product category in a given store being modeled as a product of the natural logarithm of a merchandising area for the product category times a conversion factor, times a sum of a first variable plus a second variable times a sales volume for the given store.

5. The method of claim 1, wherein the financial metric for each of the product categories comprises a mixed sales metric selected for each of the product categories, wherein the mixed sales metric defines a proportion in which sales of the product category are optimized for one or more of: unit sales, gross sales, and gross margin.

6. The method of claim 5, further comprising optimizing for the combined total of the mixed sales metric for each of the product categories in the product department in accordance with the linear regression model, within constraints of specific fixture types for the product categories.

7. The method of claim 1, wherein generating the merchandising plan for the product department further comprises optimizing within constraints of selected merchandising display criteria, comprising rules or strategies for the merchandising display of the product categories.

8. The method of claim 1, further comprising:
collecting sales data for a product department that has been merchandised in accordance with the merchandising plan;
measuring a correlation of the collected sales data against the forecasts of the linear regression model; and
revising the linear regression model based on the collected sales data.

9. The method of claim 1, wherein the endogenous variables consist only of the historical sales per product category per merchandising area for each of the plurality of stores, and the historical total sales volume for each of the plurality of stores.

10. The method of claim 1, wherein the endogenous variables for the linear regression model further comprise a geographical region.

11. The method of claim 1, wherein the endogenous variables for the linear regression model further comprise a neighborhood affluence level.

17. The method of claim 1, wherein the endogenous variables for the linear regression model further comprise a parking lot size.

13. The method of claim 1, wherein the endogenous variables for the linear regression model further comprise a measure of visibility and accessibility from major roads.

14. The method of claim 1, wherein generating the output based on the merchandising plan for the product department further comprises providing a predicted change in at least one of sales or margins for each of the product categories.

15. A computing system comprising:
one or more processors;
one or more computer-readable tangible storage devices;
a display device;
a user input device;
program instructions, stored on at least one of the one or more computer-readable tangible storage devices, to receive user inputs defining a financial metric for optimizing one or more of unit sales, gross sales, and gross margin for each of a plurality of product categories assigned to a product department;
program instructions, stored on at least one of the one or more computer-readable tangible storage devices, to provide a linear regression model that forecasts responses of the financial metrics for each of the product categories to endogenous variables, wherein the endogenous variables comprise historical sales per merchandising area per product category for each of a plurality of stores, and historical total sales volume for each of the plurality of stores;
program instructions, stored on at least one of the one or more computer-readable tangible storage devices, for each of the product categories, to enable a user option to select either a minimum and maximum of an area in which the product category may be displayed, or a minimum and maximum change from a current area in which the product category is displayed;
program instructions, stored on at least one of the one or more computer-readable tangible storage devices, to generate a merchandising plan for the product department that optimizes for the combined total of the financial metrics of the product categories for the product department in accordance with the linear regression model, within constraints of the selected minimums and maximums of display area or minimum and maximum change from the current display area for each of the product categories; and
program instructions, stored on at least one of the one or more computer-readable tangible storage devices, to generate an output based on the merchandising plan for the product department, wherein the output comprises changes in merchandising area for each of a plurality of the product categories.

16. The computing system of claim 15, wherein the financial metric for each of the product categories comprises a mixed sales metric selected for each of the product categories, wherein the mixed sales metric defines a proportion in which sales of the product category are to optimized for one or more of: unit sales, gross sales, and gross margin.

17. The computing system of claim 15, wherein the endogenous variables for the linear regression model further comprise one or more of a geographical region, a neighborhood affluence level, a parking lot size, and a measure of visibility and accessibility from major roads.

18. A computer program product comprising:
one or more computer-readable tangible storage devices;
program instructions, stored on at least one of the one or more computer-readable tangible storage devices, to receive user inputs defining a financial metric for each of a plurality of product categories assigned to a product department;
program instructions, stored on at least one of the one or more computer-readable tangible storage devices, to provide a linear regression model that forecasts predicted product category sales for each of the product categories, based on a product of the natural logarithm of a merchandising area for the product category, times a sum of a first endogenous variable that incorporates historical variation in sales per merchandising area per product category for each of a plurality of stores, plus a sales volume for the given store times a second endogenous variable that incorporates a variation in product category sales based on a total sales volume for a given store;
program instructions, stored on at least one of the one or more computer-readable tangible storage devices, to generate a merchandising plan for the product department that optimizes for the combined total of financial metrics of the product categories for the product department in accordance with the linear regression model, wherein the financial metrics are based on the predicted product category sales; and
program instructions, stored on at least one of the one or more computer-readable tangible storage devices, to generate an output based on the merchandising plan for the product department, wherein the output comprises changes in merchandising area for each of a plurality of the product categories.

19. The computer program product of claim 18, wherein the financial metric for each of the product categories comprises a mixed sales metric selected for each of the product categories, wherein the mixed sales metric defines a proportion in which sales of the product category are to optimized for one or more of: unit sales, gross sales, and gross margin.

20. The computer program product of claim 18, wherein the linear regression model is further based on endogenous variables that comprise one or more of: a geographical region, a neighborhood affluence level, a parking lot size, and a measure of visibility and accessibility from major roads.
